(19) United States
(12) Patent Application Publication
(10) Pub. No.: US 2014/0088861 A1
(43) Pub. Date: Mar. 27, 2014

(54) HISTORICAL TOURS

(71) Applicant: Reuel William NASH, Austin, TX (US)

(72) Inventor: Reuel William NASH, Austin, TX (US)

(73) Assignee: GOOGLE INC., Mountain View, CA (US)

(21) Appl. No.: 13/190,756

(22) Filed: Jul. 26, 2011

(51) Int. Cl. G01C 21/30

(52) U.S. Cl. 701/426; 701/439

(57) ABSTRACT

Systems and methods for generating a historical tour are disclosed. The historical tour may comprise historical images and information for selected geographic locations. In some aspects, the historical tour may sequentially move a view of a virtual map to each of the selected geographic locations along a path. At each geographic location, the historical tour may present the user with at least one historical image and information for the location.

### FIELD

The subject disclosure generally relates to historical tours, and, in particular, to generation of historical tours.

### BACKGROUND

A user may explore a region of the Earth by navigating a virtual map using a browser. The virtual map may comprise a two or three-dimensional representation of the Earth, which may be generated by stitching together satellite, aerial and/or street-level images and/or using three-dimensional models. The user may “fly to” a desired region (e.g., city, state, country) on the virtual map (e.g., by typing an address). The user may then explore different areas of the region (e.g., using arrow keys) and/or adjust the viewing angle of the region on the browser.

When the user visits the region, the user may be interested in learning the history of the region. For example, the user may be interested in locating historical sites in the region and learning the history of each historical site through historical imagery and/or other media.

### SUMMARY

The disclosed subject matter relates to a machine-implemented method for historical tour generation, comprising: selecting a plurality of pages, each page including a geographic location; for each of the selected pages, retrieving historical information from a database based on the corresponding geographic location; and generating a historical tour based on the geographic locations, wherein the historical tour comprises at least a portion of the historical information retrieved for the geographic locations.

The disclosed subject matter also relates to a machine-readable medium comprising instructions stored therein, which when executed by a machine, cause the machine to perform operations comprising: selecting a plurality of pages, each page including a geographic location; for each of the selected pages, retrieving historical information from a database based on the corresponding geographic location; and generating a historical tour based on the selected geographic locations, wherein the historical tour comprises at least a portion of the historical information retrieved for the geographic locations and content from at least one of the pages corresponding to the geographic locations.

The disclosed subject matter also relates to a system for historical tour generation, the system comprising: one or more processors; and a machine-readable medium comprising instructions stored therein, which when executed by the one or more processors, cause the one or more processors to perform operations comprising: selecting a plurality of pages, each page including a geographic location; for each of the selected pages, retrieving at least one historical image from a database based on the corresponding geographic location; and generating a historical imagery tour based on the geographic locations, wherein the historical imagery tour comprises at least one of the historical images retrieved for the geographic locations

The disclosed subject matter also relates to a machine-implemented method for historical tour generation, comprising: for each of a plurality of geographic locations, retrieving at least one historical image from a database corresponding to the geographic location; for each of the plurality of geographic locations, computing a score based on a date of the at least one historical image corresponding to the geographic location; selecting a subset of the plurality of geographic locations based on the scores for the plurality of geographic locations; and generating a historical tour based on the selected geographic locations, wherein the historical tour comprises at least one of the retrieved historical images.

The disclosed subject matter also relates to a machine-readable medium comprising instructions stored therein, which when executed by a machine, cause the machine to perform operations comprising: for each of a plurality of geographic locations, retrieving at least one historical image from a database corresponding to the geographic location; for each of the plurality of geographic locations, computing a score based on a date of the at least one historical image corresponding to the geographic location; selecting a subset of the plurality of geographic locations based on the scores for the plurality of geographic locations; and generating a markup language file based on the selected geographic locations, wherein the markup language file comprises instructions to sequentially move a view of a virtual map to each of the selected geographic location and to present at least one of the retrieved historical images.

The disclosed subject matter also relates to a system for historical tour generation, the system comprising: one or more processors; and a machine-readable medium comprising instructions stored therein, which when executed by the one or more processors, cause the one or more processors to perform operations comprising: determining a plurality of geographic locations that are located within a region; for each of the plurality of geographic locations, retrieving at least one historical image from a database corresponding to the geographic location; for each of the plurality of geographic locations, computing a score based on a date of the at least one historical image corresponding to the geographic location; selecting a subset of the plurality of geographic locations based on the scores for the plurality of geographic locations; and generating a historical tour of the region based on the selected geographic locations, wherein the historical tour comprises at least one of the retrieved historical images.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 shows a system according to an aspect of the subject technology.

FIG. 2 shows a historical tour system for generating a historical tour according to an aspect of the subject technology.

FIG. 3 is a flowchart showing a method for generating a historical tour according to an aspect of the subject technology.

FIG. 4 is a flowchart showing a method for generating a historical tour according to another aspect of the subject technology.

FIG. 5 conceptually illustrates an electronic system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

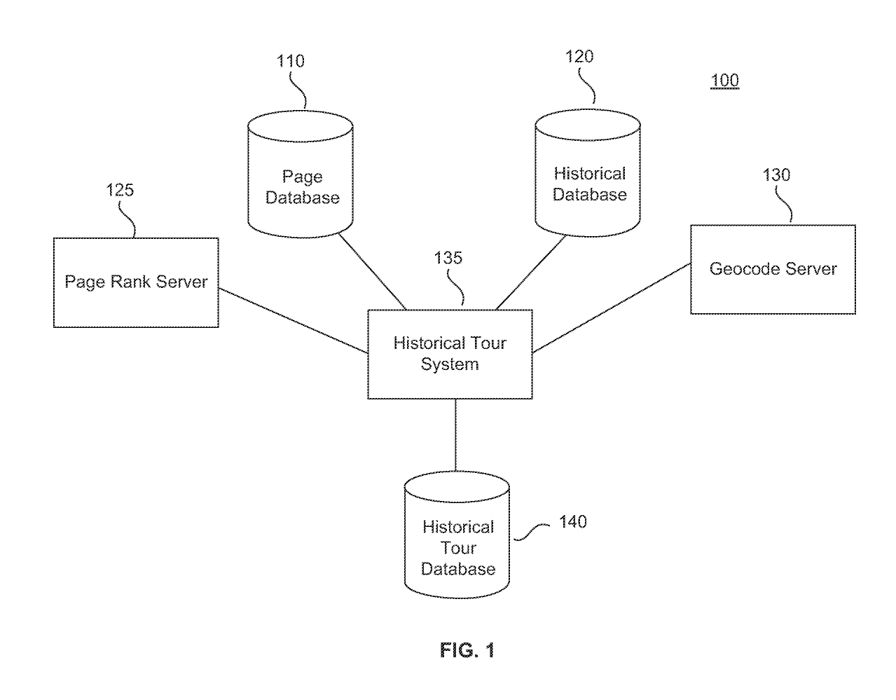

FIG. 1 shows a system 100 according to an aspect of the subject technology. The system 100 may comprise a page database 110, a historical database 120, a page rank server 125, a geocode server 130, a historical tour system 135, and a historical tour database 140. In one aspect, the historical tour system 135 may be configured to generate a historical tour of a region using the page database 110, the historical database 120, the page rank server 125, and the geocode server 130, as discussed further below. The historical tour, which may be in the form of a keyhole markup language (KML) file, may sequentially move a view of a virtual map to each of a plurality of geographic locations along a path. At each geographic location, the historical tour may present the user with at least one historical image and information for the location.

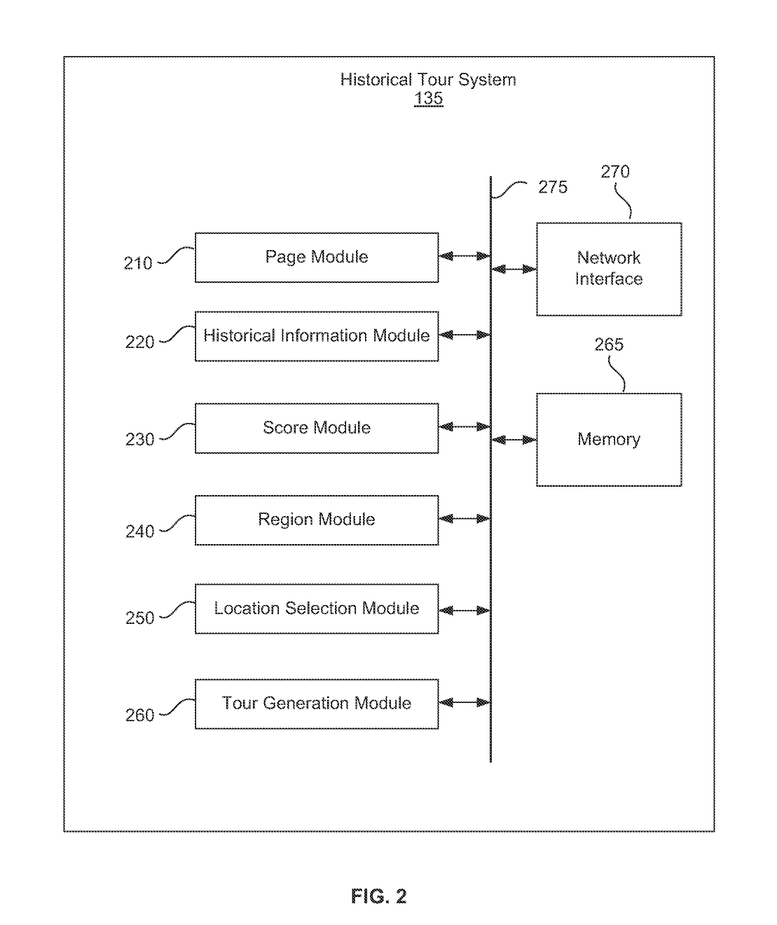

Referring to FIG. 2, the historical tour system 135 may include a page module 210, a historical information module 220, a score module 230, a region module 240, a location selection module 250 and a tour generation module 260. The modules may communication with one another using various communications protocols via a bus 275 or other communication structure. For example, the modules may be implemented on one or more processors that execute software to perform the various functions of the modules described herein. For modules implemented on the same processor, the modules may communicate with one another via shared memory, interprocess communication structure and/or other communication structure. In another example, the modules may be implemented on distributed computing systems, in which modules implemented on different computing systems may communicate with one another via a network.

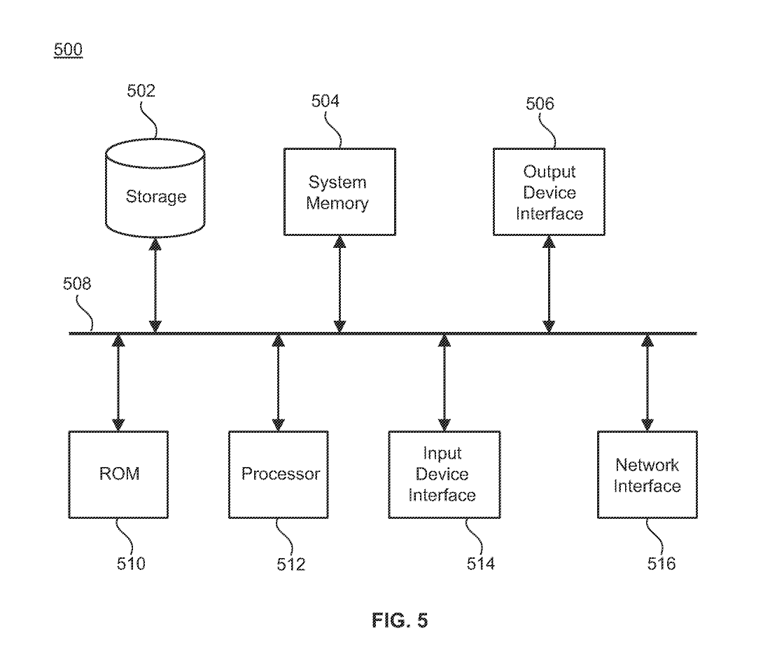

The historical tour system 135 may also include a network interface 270 that allows each of the modules to communicate with one or more of the databases and/or servers show in FIG. 1 over a network connection. The historical tour system 135 may also include memory 265, which may be shared by the modules and used to pass information between the modules. An example of an electronic system in which the modules may be implemented is described with reference to FIG. 5 below. Processes of each of the modules according to various aspects of the subject technology will now be described with reference to FIGS. 1 and 2.

The page module 210 may be configured to download a plurality of pages (e.g., web pages) from the page database 110 via the network interface 270. For example, the page database 110 may include a Wikipedia database (URL: www.wikipedia.org) and/or other online encyclopedia database. In another example, the page database 110 may include a geographic information system (GIS) database with geographically referenced data. Although only one page database 110 is shown in FIG. 1, it is to be understood that the page module 210 may download pages from more than one page database. In one aspect, the page module 210 may periodically search the page database 110 (e.g., monthly) for recently added pages and download the recently added pages.

After downloading a plurality of pages from the page database 110, the page module 210 may determine which of the pages have location information specifying a geographic location. For example, a page including an article about a particular place (e.g., historical landmark) may also include location information specifying a geographic location of the place. Each page having location information may specify the corresponding geographic location in a well-defined format (e.g., latitude and longitude coordinates) that can be easily identified by the page module 210. The page module 210 may select the pages having location information for further processing by the historical tour system 135, and discard the pages without location information.

For each page selected by the page module 210, the historical information module 220 may retrieve historical information for the corresponding geographic location from the historical database 120 via the network interface 270. For example, the historical information may include one or more historical images for the geographic location including a date for each historical image.

In one aspect, the historical database 120 may comprise a historical image database that stores historical images. Each historical image may be indexed by a geographic area, and may comprise a satellite image, aerial image, and/or street-level image. For each historical image, the historical image database may also include a date (e.g., the date the image was taken). In this aspect, for each selected page, the historical information module 220 may retrieve historical images for the corresponding geographic location from the historical image database including the dates of the images. For example, the historical information module 220 may retrieve historical images that are indexed by geographic areas that include the corresponding geographic location.

In one aspect, the historical image database may store the historical images using a tree structure (e.g., quadtree structure), in which an image at a higher level in the tree structure shows a larger geographic area of the Earth with a lower level of detail, and an image at a lower level in the tree structure shows a smaller geographic area of the Earth with a higher level of detail. In this example, the historical image database may be used by an Earth browser to allow a user to navigate a virtual map of the Earth at a selected date. The Earth browser may do this by retrieving historical images from the tree structure (e.g., quadtree structure) corresponding to the portion of the Earth being viewed by the user and the selected date, and stitching together the historical images to provide the user with a virtual map of that portion of the Earth at the selected date. The Earth browser may display a time slider that allows the user to select the date by sliding the time slider along a timeline to the date. For example, the user may use this feature to view how a section of Las Vegas, Nev. has changed over time. In this aspect, for each selected page, the historical information module 220 may retrieve historical images for the corresponding geographic location from the tree structure (e.g., quadtree structure) including the dates of the images. Further, the historical information module 220 may only retrieve historical images that have at least a minimum level of detail. For the example, the historical information module 220 may only retrieve historical images at levels in the tree structure (e.g., quadtree structure) corresponding to levels of detail that are equal to or greater than the minimum level of detail.

After historical information is retrieved for the geographic location of a selected page, the score module 230 may compute a score for the geographic location based on one or more of the components discussed below.

A first component may comprise a page rank of the page. In this example, the score module 230 may obtain the page rank of the page by sending a page rank request for the page to the page rank server 125, and receiving the page rank from the page rank server 125 in response to the request via the network interface 270. The page rank may be a value indicating the importance or popularity of the page, in which a higher value corresponds to a higher level of importance or popularity. The page rank may be based on the number of other pages linking to the page, the page ranks of the other pages linking to the page, and/or other factors. Page ranks may be used by a search engine to rank search results. Since the page rank indicates the importance or popularity of the page, the score module 230 may use the page rank as an indicator of the likelihood that a user will be interested in learning the history of the corresponding geographic location.

A second component may comprise the number of historical images retrieved from the historical database 120 for the geographic location.

A third component may be based on the age of one or more of the historical images retrieved for the geographic location. For example, the third component may be based on the age of the oldest historical image. In this example, the third component may be assigned a higher value the greater the age of the oldest historical image. In another example, the third component may be based on an average of the dates of the historical images. In this example, the third component may be assigned a higher value the older the average date of the historical images.

A fourth component may be based on a correlation between dates in the page and the dates of the historical images retrieved for the geographic location. In this example, the page module 210 may be configured to extract dates from the content (e.g., text and/or information box(es)) of the page. The dates may be in various formats instead of a single well-defined format. For example, the date of Nov. 21, 1990 may be specified as 11-21-1990, 11/21/1990 or other format. To handle various formats, the score module 230 may be configured to recognize dates in various formats. In one aspect, the page module 210 may recognize a term that corresponds to a date and determine a date from the term. For example, the page module 210 may recognize that the term “World War II” corresponds to a date within a range of years (e.g., 1935 and 1945).

In this aspect, after dates are extracted from the page by the page module 210, the score module 230 may assign a value to the fourth component based on a correlation of the dates in the page with the dates of the historical images retrieved for the geographic location. For example, the score module 230 may assign a higher value to the fourth component when one of the dates in the page is the same as or within a small range (e.g., five years) of one or more of the dates of the historical images. For the case where the page module 210 can only resolve a date in the page to within a range of years (e.g., 1935 to 1945 for “World War II”), the score module 230 may assign a higher value to the fourth component when the range of years overlaps with one or more of the dates of the historical images.

After the score module 230 determines one or more of the above components, the score module 230 may compute a score for the geographic location based on the one or more components. For example, the score module 230 may assign the geographic location a score equal to one of the components. In another example, the score module 230 may compute a weighted sum of two or more of the components and assign the geographic location a score based on the weighted sum. In yet another example, the score module 230 may compute a product of two or more of the components and assign the geographic location a score based on the product. If the score for the geographic location does not meet a minimum score threshold, then the score module 230 may eliminate the geographic location and the corresponding page from further consideration by the historical tour system 135.

The score module 230 may perform the above process for each of the selected pages to compute a score for the corresponding geographic location.

For each of the geographic locations, the region module 240 may determine one or more regions (e.g., city, zip code, county, state and/or country) within which the geographic location is located and associate the one or more determined regions with the geographic location. For example, for a geographic location in San Francisco, the associated regions may include San Francisco, Calif. and the United States of America.

In one aspect, the region module 240 may determine one or more regions for a geographic location by sending a reverse geocode request to the geocode server 130 for the geographic location, and receiving one or more regions from the geocode server 130 in response to the request via the network interface 270. The geocode server 130 may be configured to gecode a region, in which the region is converted into a geographic location (e.g., a geographic location in the center of the region), and to reverse geocode a geographic location, in which the geographic location is converted into one or more regions. In this aspect, the region module 240 may limit the rate at which it sends reverse geocode requests to the geocode server 130 to allow other clients to request services from the geocode server 130.

For each of a plurality of different regions, the region module 240 may determine which of the geographic locations are located within the region (e.g., city, zip code, county, state and/or country). For each region, the region module 240 may determine whether a particular geographic location is located within the region by determining whether one of the regions associated with the location matches the region.

Thus, for each page downloaded from the page database 110, the page module 210 selects the pages having location information specifying a geographic location. For each page selected by the page module 210, the historical information module 220 retrieves historical information for the corresponding geographic location from the historical database 120, the score module 230 computes a score for the corresponding geographic location, and the region module 240 determines one or more regions for the corresponding geographic location. For each region, the region module 240 also determines which of the geographic locations are located within the region. The above information may be stored in the memory 265. As discussed further below, the location selection module 250 may use the above information to determine which of the geographic locations to include in a historical tour of a region.

The location selection module 250 is configured to select which of the geographic locations to include in a historical tour of a region. To do this, the location selection module 250 may first retrieve the geographic locations that are located within the region from the memory 265, as determined by the region module 240. The location selection module 250 may treat the geographic locations located within the region as candidates for inclusion in the historical tour of the region. After retrieving the geographic locations within the region, the location selection module 250 may retrieve the scores computed for the geographic locations by the score module 230 from the memory 265. The location selection module 250 may then select which of the geographic locations within the region to include in the historical tour of the region based on the scores for the geographic locations.

In one aspect, the location selection module 250 may select the geographic locations within the region having the N highest scores (e.g., 20 highest scores) for inclusion in the historical tour of the region. If the region has fewer than M locations (where M<N), then the location selection module 250 may instruct the tour generation module 260 to skip generating a historical tour of the region. In this case, a historical tour of the region is not generated. If the number of locations within the region is between M and N, then the location selection module 250 may select all of the locations regardless of their scores.

In another aspect, the location selection module 250 may cluster the geographic locations within the region into a plurality of clusters according to location. The location selection module 250 may do this by applying a clustering algorithm (e.g., a k-means clustering algorithm) to the geographic locations, in which the geographic locations in the same cluster are geographically close to one another. After the geographic locations are clustered into the plurality of clusters, the location selection module 250 may select the highest scoring location in each cluster for the historical tour. This aspect may be used to provide geographically diverse locations for the historical tour.

In another aspect, the location selection module 250 may cluster the geographic locations within the region into a plurality of clusters according to the dates of their corresponding historical images. In this aspect, the geographic locations in the same cluster may have corresponding imagery dates that are spaced close to one another in time. After the geographic locations are clustered into the plurality of clusters, the location selection module 250 may select the highest scoring location in each cluster for the historical tour. This may be done to provide a historical tour having historical images that are diverse in time. In another example, the location selection module 250 may select the locations within a particular cluster for the historical tour. This may be done to provide a historical tour for a particular time period (e.g., 1970's).

The location selection module 250 may also use any combination of the above techniques to select geographic locations within the region for inclusion in the historical tour of the region. For example, the location selection module 250 may first cluster the geographic locations within the region into a plurality of clusters according to location and select the top scoring geographic location in each cluster. Of these geographic locations, the historical tour system 135 may then select the locations having the N highest scores for the historical tour.

The location selection module 250 may perform the above process for each of a plurality of different regions to select the geographic locations for inclusion in the historical tour of the region.

After the location selection module 250 selects the geographic locations for inclusion in the historical tour of a region, the tour generation module 260 generates the historical image tour of the region based on the selected geographic locations. The historical image tour may be in the form of a Keyhole Markup Language (KML) file that, when interpreted by an Earth browser, sequentially moves a view of a virtual map to each of the selected geographic locations along a path. The virtual map may provide a two or three-dimensional representation of the Earth, which may be generated by stitching together satellite, aerial and/or street level images and/or using three-dimensional models. The tour generation module 260 may order the locations in the historical tour based on an order that results in the shortest path. An example of an Earth browser on which the historical tour may be presented is Google Earth®. However, one skilled in the art will appreciate that the historical tour may be present using any application or service that provides a two or three-dimensional representation of the Earth.

At each selected geographic location, the historical tour may present the user with one or more of the historical images retrieved from the historical database 120 for the location. The historical tour may also present content from the corresponding page (i.e., the page that included the location information specifying the geographic location). The content may include text and/or images extracted from the page. The historical images and/or content from the corresponding page may be presented in a bubble and/or screen overlay. The historical tour may also include a link to the page and/or one or more links included in the page. The user may click on the link to obtain additional information about the location. In one aspect, the historical tour may also instruct the Earth browser to show the region at a date corresponding to a date of one of the historical images and/or a date in the page.

After generating the historical tour of the region, the tour generation module 260 may store the historical tour in the historical tour database 140. The tour generation module 260 may perform the above process for each of a plurality of regions to generate a historical tour of each region, and store the historical tour of each region in the historical tour database 140.

When a user navigates to a particular region using an Earth browser running on a computing device, the Earth browser may determine whether a historical tour is available for the region in the historical tour database 140. If a historical tour is available, then the Earth browser may display an icon representing the historical tour. The user may launch the historical tour, for example, by clicking on the icon. For the example in which the historical tour is in the form of a KML file, the Earth browser may retrieve the KML file from the historical tour database 140 and process the KML file to render the historical tour.

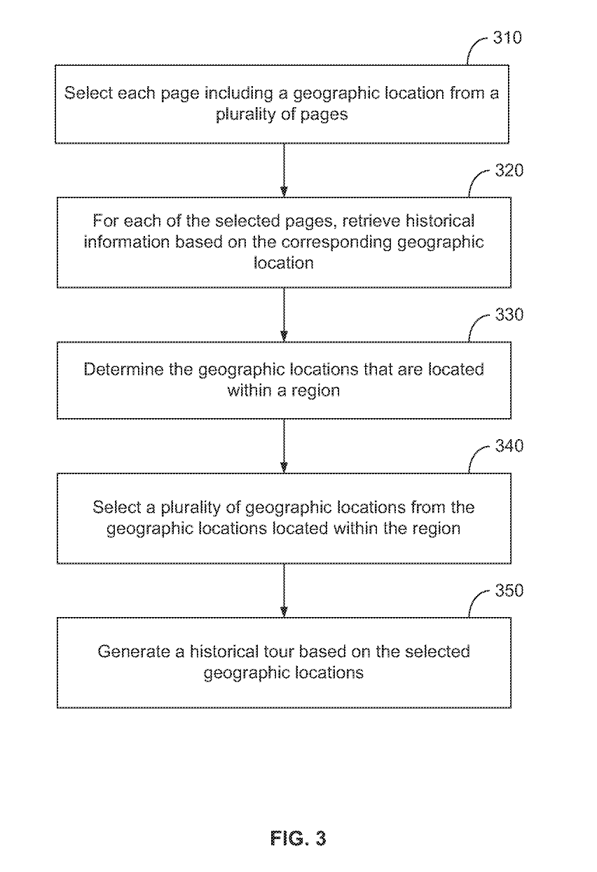

FIG. 3 is a flowchart illustrating a method for historical tour generation according to an aspect of the subject technology. At step 310, each page including a geographic location is selected from a plurality of pages. At step 320, for each of the selected pages, historical information is retrieved from a database based on the corresponding geographic location. At step 330, the geographic locations that are located within a region are determined. At step 340, a plurality of geographic locations are selected from the geographic locations located within the region. At step 350, a historical tour of the region is generated based on the selected geographic locations. The historical tour may comprise at least a portion of the historical information retrieved for the selected geographic locations. Steps 330 through 350 may be repeated to generate a historical tour for each of a plurality of different regions.

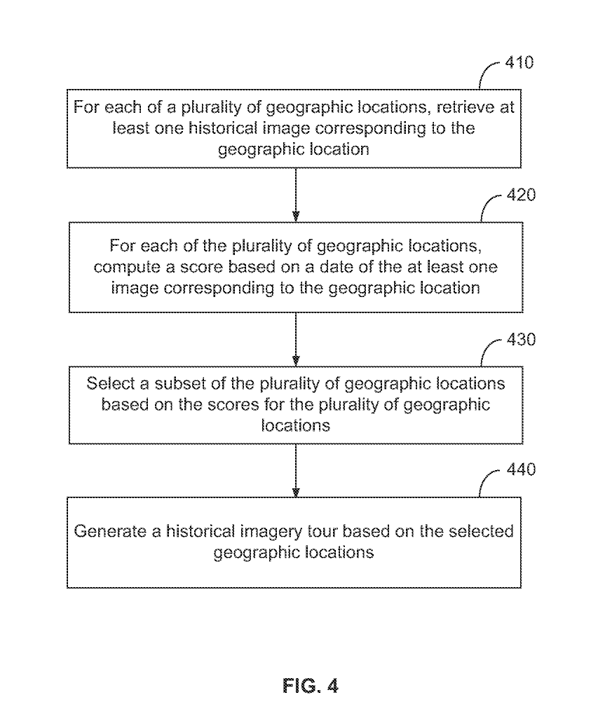

FIG. 4 is a flowchart illustrating a method for historical tour generation according to an aspect of the subject technology. At step 410, for each of a plurality of geographic locations, at least one historical image is retrieved from a database corresponding to the geographic location. The plurality of geographic locations may be located within the same region. At step 420, for each of the plurality of geographic locations, a score is computed based on a date of the at least one historical image corresponding to the geographic location. At step 430, a subset of the plurality of geographic locations is selected based on the scores for the plurality of geographic locations. At step 440, a historical imagery tour is generated based on the selected geographic locations, wherein the historical tour comprises at least one of the retrieved historical images.

FIG. 5 conceptually illustrates an electronic system with which some implementations of the subject technology may be implemented. For example, the electronic system may be used to implement the historical tour system 135 illustrated in FIG. 2. Electronic system 500 includes a bus 508, processing unit(s) 512, a system memory 504, a read-only memory (ROM) 510, a permanent storage device 502, an input device interface 514, an output device interface 506 and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. For example, each module of the historical tour system 135 may include instructions that are stored in one or more of the memory units and executed by the processing unit(s) 512 to implement the processes of the module. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD).

Finally, as shown in FIG. 5, bus 508 also couples electronic system 500 to a network (not shown) through a network interface 516. In this manner, the electronic system 500 can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A machine-implemented method for historical tour generation, comprising:
selecting a plurality of pages, each page including a geographic location, wherein selecting the plurality of pages includes discarding pages without geographic information;
for each of the selected pages, retrieving historical information from a database based on the corresponding geographic location; and
generating a historical tour based on the geographic locations, wherein the historical tour comprises at least a portion of the historical information retrieved for the geographic locations.

2. The method of claim 1, wherein the historical information retrieved for the geographic locations includes a plurality of historical images, and the historical tour comprises at least one of the historical images.

3. The method of claim 1, wherein the historical tour comprises content from at least one of the pages corresponding to the geographic locations.

4. The method of claim 4, wherein the historical tour comprises a link to at least one of the pages corresponding to the geographic locations.

5. The method of claim 1, further comprising:
for each of the selected pages, performing the steps of:
retrieving a page rank for the page; and
computing a score for the corresponding geographic location based on the page rank and the historical information retrieved for the geographic location; and
selecting one or more of the geographic locations based on the computed scores for the geographic locations, wherein the tour is based on the one or more selected geographic locations.

6. The method of claim 5, wherein the selecting the one or more geographic locations comprises selecting the geographic locations having the N highest computed scores, where N is an integer.

7. The method of claim 1, further comprising:
clustering the geographic locations into a plurality of clusters according to location; and
selecting one or more of the geographic locations based on the plurality of clusters, wherein the tour is based on the one or more selected geographic locations.

8. The method of claim 1, further comprising:
for each of the selected pages, performing the steps of:
extracting dates from the historical information retrieved for the corresponding geographic location; and
computing a score for the corresponding geographic location based on the extracted dates; and
selecting one or more of the geographic locations based on the computed scores for the geographic locations, wherein the tour is based on the one or more selected geographic locations.

9. The method of claim 8, wherein the selecting the one or more geographic locations comprises selecting the geographic locations having the N highest computed scores, where N is an integer.

10. The method of claim 8, further comprising:
for each of the selected pages, performing the steps of:
extracting dates from the page; and
correlating the dates extracted from the page with the dates extracted from the historical information retrieved for the corresponding geographic location,
wherein the computed score for the corresponding geographic location is based on the correlation.

11. The method of claim 1, further comprising:
clustering the geographic locations into a plurality of clusters according to dates in the corresponding historical information; and
selecting one or more of the geographic locations based on the plurality of clusters, wherein the tour is based on the one or more selected geographic locations

12. The method of claim 1, wherein the historical tour is generated as a markup language file including instructions to sequentially move a view of a virtual map to each of the geographic locations in the tour.

13. The method of claim 12, wherein the markup language file is a keyhole markup language (KML) file.

14. The method of claim 1, further comprising determining which of the geographic locations are located within a geographic region, wherein the tour is based on the geographic locations located within the geographic region.

15. A machine-readable medium comprising instructions stored therein, which when executed by a machine, cause the machine to perform operations comprising:
selecting a plurality of pages, each page including a geographic location, wherein selecting the plurality of pages includes discarding pages without geographic information;
for each of the selected pages, retrieving historical information from a database based on the corresponding geographic location; and
generating a historical tour based on the selected geographic locations, wherein the historical tour comprises at least a portion of the historical information retrieved for the geographic locations and content from at least one of the pages corresponding to the geographic locations.

16. A system for historical tour generation, the system comprising:
one or more processors; and
a machine-readable medium comprising instructions stored therein, which when executed by the one or more processors, cause the one or more processors to perform operations comprising:
selecting a plurality of pages, each page including a geographic location, wherein selecting the plurality of pages includes discarding pages without geographic information;
for each of the selected pages, retrieving at least one historical image from a database based on the corresponding geographic location; and
generating a historical imagery tour based on the geographic locations, wherein the historical imagery tour comprises at least one of the historical images retrieved for the selected geographic locations.

17. A machine-implemented method for historical tour generation, comprising:
selecting a plurality of pages, each page including a geographic location, wherein selecting the plurality of pages includes discarding pages without geographic information;
for each of a plurality of geographic locations, retrieving at least one historical image from a database corresponding to the geographic location;
for each of the plurality of geographic locations, computing a score based on a date of the at least one historical image corresponding to the geographic location;
selecting a subset of the plurality of geographic locations based on the scores for the plurality of geographic locations; and
generating a historical tour based on the selected geographic locations, wherein the historical tour comprises at least one of the retrieved historical images.

18. The method of claim 17, wherein the score for each of the geographic locations is based on an age of the at least one historical image corresponding to the geographic location.

19. The method of claim 17, further comprising, for each of the plurality of geographic locations, determining a page rank of a page that includes the geographic location, wherein the score for each of the geographic locations is also based on the corresponding page rank.

20. The method of claim 17, wherein the historical tour is generated as a markup language file comprising instructions to sequentially move a view of a virtual map to each of the selected geographic locations.

21. The method of claim 17, wherein the markup language file is a keyhole markup language (KML) file.

22. The method of claim 17, wherein the plurality of geographic locations are located within a region.

23. The method of claim 17, wherein the selecting the subset of the plurality of geographic locations comprises selecting the geographic locations having the N highest computed scores, where N is an integer.

24. A machine-readable medium comprising instructions stored therein, which when executed by a machine, cause the machine to perform operations comprising:
selecting a plurality of pages, each page including a geographic location, wherein selecting the plurality of pages includes discarding each page without geographic information;
for each of a plurality of geographic locations, retrieving at least one historical image from a database corresponding to the geographic location;
for each of the plurality of geographic locations, computing a score based on a date of the at least one historical image corresponding to the geographic location;
selecting a subset of the plurality of geographic locations based on the scores for the plurality of geographic locations; and
generating a markup language file based on the selected geographic locations, wherein the markup language file comprises instructions to sequentially move a view of a virtual map to each of the selected geographic location and to present at least one of the retrieved historical images.

25. A system for historical tour generation, the system comprising:
one or more processors; and
a machine-readable medium comprising instructions stored therein, which when executed by the one or more processors, cause the one or more processors to perform operations comprising:
selecting a plurality of pages, each page including a geographic location, wherein selecting the plurality of pages includes discarding pages without geographic information;
determining a plurality of geographic locations that are located within a region;
for each of the plurality of geographic locations, retrieving at least one historical image from a database corresponding to the geographic location;
for each of the plurality of geographic locations, computing a score based on a date of the at least one historical image corresponding to the geographic location;
selecting a subset of the plurality of geographic locations based on the scores for the plurality of geographic locations; and
generating a historical tour of the region based on the selected geographic locations, wherein the historical tour comprises at least one of the retrieved historical images
